(19) United States
(12) Patent Application Publication
(10) Pub. No.: US 2011/0153337 A1
(43) Pub. Date: Jun. 23, 2011

(54) ENCODING APPARATUS AND METHOD AND DECODING APPARATUS AND METHOD OF AUDIO/VOICE SIGNAL PROCESSING APPARATUS

(75) Inventors: Hyun-Woo KIM, Daejeon-si (KR); Jong-Mo SUNG, Daejeon-si (KR); Mi-Suk LEE, Daejeon-si (KR); Hee-Sik YANG, Gimhae-si (KR); Hyun-Joo BAE, Daejeon-si (KR); Byung-Sun LEE, Daejeon-si (KR)

(73) Assignee: Electronics and Telecommunications Research Institute, Daejeon-si (KR)

(21) Appl. No.: 12/957,027

(22) Filed: Nov. 30, 2010

(30) Foreign Application Priority Data
Dec. 17, 2009 (KR) 10-2009-0126243
Jul. 27, 2010 (KR) 10-2010-0072512

(51) Int. Cl. G10L 19/00

(52) U.S. Cl. 704/501; 704/500; 704/E19.001

(57) ABSTRACT

An encoding apparatus is provided. The encoding apparatus includes a track structure determiner determining a track structure using frequency coefficients, a frequency coefficient allocator allocating the frequency coefficients to each track according to the determined track structure, and a quantizer quantizing one or more pulses in each track based on a number of frequency coefficients allocated to a corresponding track. The encoding apparatus can prevent the degradation of sound quality by avoiding the problem faced by most sinusoidal quantization techniques using a fixed track structure, i.e., a failure to quantize all pulses due to mismatches between the pulse distribution of frequency coefficients and a track structure.

### CROSS-REFERENCE TO RELATED APPLICATION(S)

This application claims the benefit under 35 U.S.C. §119(a) of Korean Patent Application No. 10-2009-0126243 filed on Dec. 17, 2009, and Korean Patent Application No. 10-2010-0072512 filed on Jul. 27, 2010, in the Korean Intellectual Property Office, the entire disclosures of which are incorporated herein by reference for all purposes.

### BACKGROUND

1. Field

The following description relates to audio signal processing, and particularly, to encoding and decoding technologies for use in an audio/voice signal processing apparatus.

2. Description of the Related Art

Pulse code modulation (PCM) signals can be obtained by performing sampling and uniform quantization on analog audio signals. Since PCM signals are generally large in size, they are difficult to store, transmit and restore unless compressed. Therefore, various audio/voice codecs for compressing and restoring PCM signals have been developed. Most recent audio/voice codecs convert a time-domain input signal into a frequency-domain signal and then quantize the frequency-domain signal.

There are various quantization methods available, such as tree-structured quantization, product quantization, lattice quantization, predictive quantization, address quantization, fine-coarse quantization, multistage quantization, Trellis-coded quantization and pyramid quantization.

The product quantization method is characterized by classifying frequency coefficients into one or more sub-bands and quantizing each of the sub-bands. In the product quantization method, the gains of sub-band frequency coefficients are scalar-quantized, and the shapes of the sub-band frequency coefficients are vector-quantized. However, if when the distribution of the sub-band frequency coefficients has the shape of a pulse, there is a clear limit in precisely representing the pulse shape through vector quantization.

As part of the effort to solve the above-mentioned problem, the sinusoidal quantization method has been developed. The sinusoidal quantization method is characterized by classifying frequency coefficients into one or more tracks (i.e., sub-bands), selecting one or more pulses from each of the tracks in decreasing order of the absolute values of frequency coefficients classified into a corresponding track and quantizing the locations and amplitudes of the selected pulses.

### SUMMARY

The following description relates to encoding and decoding technologies for use in an audio/voice signal processing apparatus.

In one general aspect, there is provided an encoding apparatus including a track structure determiner determining a track structure using frequency coefficients; a frequency coefficient allocator allocating the frequency coefficients to each track according to the determined track structure; and a quantizer quantizing one or more pulses in each track based on a number of frequency coefficients allocated to a corresponding track.

In another general aspect, there is provided a decoding apparatus including an inverse quantizer restoring pulse parameters by inversely quantizing quantized pulse parameters included in an input bitstream; a track structure determiner determining a track structure based on a track parameter included in the input bitstream; a pulse generator generating pulses based on the restored pulse parameters; and a coefficient generator generating frequency coefficients based on the determined track structure and the generated pulses.

In another general aspect, there is provided a method of encoding an audio signal, the method including calculating the energy concentration levels of a plurality of track structures based on frequency coefficients; selecting one of the plurality of track structures based on the calculated energy concentration levels; allocating the frequency coefficients to each track according to the selected track structure; selecting one or more pulses from each track; and quantizing the selected pulses.

In another general aspect, there is provided a method of decoding an audio signal, the method including determining a track structure based on a track parameter included in an input bitstream; restoring pulse parameters from the input bitstream by inversely quantizing the input bitstream; generating pulses based on the restored pulse parameters; and generating frequency coefficients based on the determined track structure and the generated pulses.

Other features and aspects may be apparent from the following detailed description, the drawings, and the claims.

### BRIEF DESCRIPTION OF THE DRAWINGS

FIG. 1 is a block diagram of a typical audio signal processing apparatus;

FIG. 2 is a block diagram of an example audio signal processing apparatus;

FIG. 3 is a flowchart of an example method of encoding an audio signal; and

FIG. 4 is a flowchart of an example method of decoding an audio signal.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

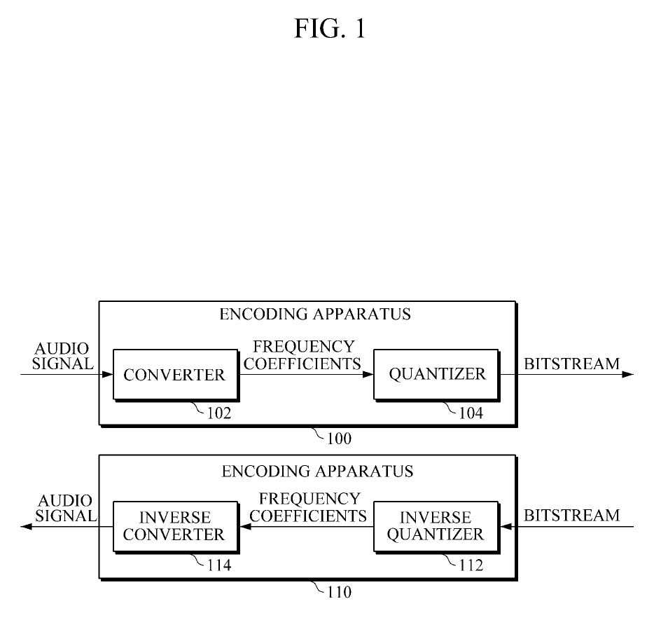

FIG. 1 is a block diagram of a typical audio signal processing apparatus. Referring to FIG. 1, the audio signal processing apparatus may include an encoding apparatus 100 and a decoding apparatus 110.

The encoding apparatus 100 may encode the quantization indexes of frequency coefficients and may thus generate a bitstream. The bitstream may be transmitted to another terminal device via a storage medium or a communication channel. The encoding apparatus 100 may include a converter 102 and a quantizer 104.

The converter 102 may convert an input signal (such as an audio/voice signal) from a time domain to a frequency signal. The quantizer 104 may quantize frequency coefficients obtained from the input signal and may thus obtain a bitstream.

The quantizer 104 may use various quantization techniques such as predictive quantization in order to improve its quantization performance.

The decoding apparatus 110 may obtain frequency coefficients from an input bitstream, and may convert the frequency coefficients to a time domain, thereby restoring an original input signal.

More specifically, the decoding apparatus 110 may include an inverse quantizer 112 and an inverse converter 114. The inverse quantizer 112 may obtain frequency coefficients from the input bitstream. The inverse converter 114 may convert the frequency coefficients to the time domain, and may thus restore the original audio signal. Thereafter, the inverse converter 114 may output the restored audio signal.

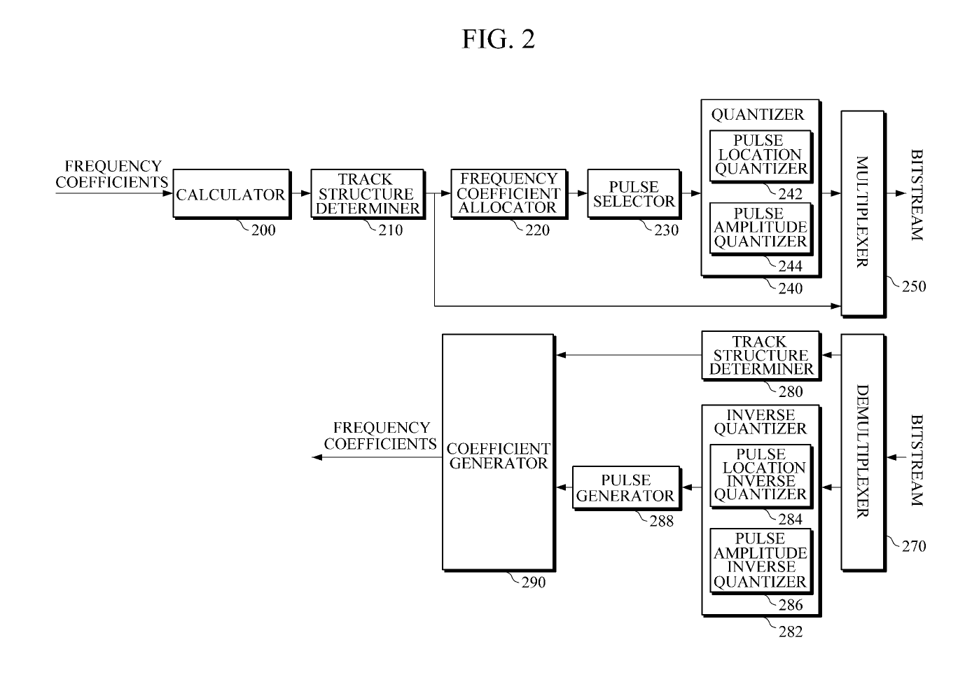

FIG. 2 is a block diagram of an example audio signal processing apparatus. Referring to FIG. 2, the audio signal processing apparatus may include a calculator 200, a track structure determiner 210, a frequency coefficient allocator 220, a pulse determiner 230, a quantizer 240, a multiplexer 250, a demultiplexer 270, an inverse quantizer 282, a pulse generator 288 and a coefficient generator 290.

The calculator 200 may calculate the energy concentration level of each track structure based on frequency coefficients obtained from an input signal (such as an audio/voice signal). There are 2 types of track structures: a sequential track structure and an interleave track structure.

For example, when there are 2 track structures (i.e., track structures 1 and 2), 64 frequency coefficients and 4 tracks (i.e., tracks 1 through 4, each having 2 pulses), the energy concentration levels of track structures 1 and 2 can be represented by Equation (1):

$${EC}_{structure 1} = {\sum }_{track = 0}^{3} \frac{{MAX 2}_{i = 0 , … , 15} {( spec ( 16 \times track + i ) )}^{2}}{\frac{1}{15} {\sum }_{i = 0}^{15} {( spec ( 16 \times track + i ) )}^{2}}$$

$${EC}_{structure 2} = {\sum }_{track = 0}^{3} \frac{{MAX 2}_{i = 0 , … , 15} {( spec ( 4 \times i + track ) )}^{2}}{\frac{1}{15} {\sum }_{i = 0}^{15} {( spec ( 4 \times i + track ) )}^{2}}$$

where

$${MAX 2}_{i = 0 , … , 15}$$

indicates 2 greatest frequency coefficients in absolute value among the frequency coefficients allocated to each of tracks 1 through 4. Referring to Equation (1), if there are 4 pulses available on each of tracks 1 through 4,

$${MAX 2}_{i = 0 , … , 15}$$

may be replaced with

$${MAX 4}_{i = 0 , … , 15}$$

where

$${MAX 4}_{i = 0 , … , 15}$$

indicates 4 greatest frequency coefficients in absolute value among the frequency coefficients allocated to each of tracks 1 through 4. In this manner, the calculator 200 may calculate the energy concentration levels of track structures 1 and 2 based on the number of pulses available on each of tracks 1 through 4.

The calculator 200 may calculate the total energy levels of track structures 1 and 2, as indicated by Equation (2):

$${ET}_{structure 1} = {\sum }_{track = 0}^{3} {MAX 2}_{i = 0 , … , 15} {( spec ( 16 \times track + i ) )}^{2}$$

$${ET}_{structure 2} = {\sum }_{track = 0}^{3} {MAX 2}_{i = 0 , … , 15} {( spec ( 4 \times i + track ) )}^{2}$$

where

$${MAX 2}_{i = 0 , … , 15}$$

indicates 2 greatest frequency coefficients in absolute value among the frequency coefficients allocated to each of tracks 1 through 4. Referring to Equation (2), if there are 4 pulses available on each of tracks 1 through 4,

$${MAX 2}_{i = 0 , … , 15}$$

may be replaced with

$${MAX 4}_{i = 0 , … , 15}$$

where

$${MAX 4}_{i = 0 , … , 15}$$

indicates 4 greatest frequency coefficients in absolute value among the frequency coefficients allocated to each of tracks 1 through 4. In this manner, the calculator 200 may calculate the total energy levels of track structures 1 and 2 based on the number of pulses available on each of tracks 1 through 4.

The track structure determiner 210 may select one of track structures 1 and 2 by comparing track structures 1 and 2 in terms of energy concentration or total energy. More specifically, the track structure determiner 210 may select one of track structures 1 and 2 by comparing their energy concentration levels. For example, if EC_{structure1}>γ×EC_{structure2} (where γ is a value within the range of 0.8 to 1.2), the track structure determiner 210 may select track to structure 1. On the other hand, if γ×EC_{structure2}>EC_{structure1}, the track structure determiner 210 may select track structure 2. Alternatively, the track structure determiner 210 may select one of track structures 1 and 2 by comparing their total energy levels. For example, if ET_{structure1}>γ×ET_{structure2}, the structure determiner 210 may select track structure 1. On the other hand, if γ×ET_{structure2}>ET_{structure1}, the structure determiner 210 may select track structure 2.

The frequency coefficient allocator 220 may allocate the frequency coefficients obtained from the input signal to tracks 1 through 4 according to the track structure selected by the track structure determiner 210. For example, if the track structure selected by the track structure determiner 210 is track structure 2, a new coefficient VEC_{track}(i) may be allocated to each of tracks 1 through 4, as indicated by the following formulae:

VEC_{track1}(i)=spec(4×i), i=0, . . . , 15

VEC_{track2}(i)=spec(4×i+1), i=0, . . . , 15

VEC_{track3}(i)=spec(4×i+2), i=0, . . . , 15

VEC_{track4}(i)=spec(4×i+3), i=0, . . . , 15.

The pulse determiner 230 may select a number of pulses from each of tracks 1 through 4 in decreasing order of the absolute values of the frequency coefficients obtained from the input signal. For example, the pulse determiner 230 may select 2 greatest frequency coefficients in absolute value from each of tracks 1 through 4.

The quantizer 240 may include a pulse location quantizer 242 and a pulse amplitude quantizer 244. The pulse location quantizer 242 may quantize location information of pulses selected by the pulse determiner 230, and the pulse amplitude quantizer 244 may quantize amplitude information of the pulses selected by the pulse determiner 230.

More specifically, the pulse location quantizer 242 may quantize location information of pulses selected from each of tracks 1 through 4 using a predefined number of bits. The number of bits used to quantize the pulse location information may be determined by the number of pulse locations discovered from each of tracks 1 through 4. For example, pulse location information of a track having 8 pulse locations thereon may be quantized using 3 bits. More specifically, if there are 16 pulse locations on track 1, pulse location information of the first track may be quantized using 4 bits. If there are 8 pulse locations on tracks 2 and 3, respectively, pulse location information of each of tracks 2 and 3 may be quantized using 3 bits. If there are 4 pulse locations on track 4, pulse location information of track 4 may be quantized using 2 bits.

The pulse amplitude quantizer 244 may quantize amplitude information of pulses selected from each of tracks 1 through 4 using a predefined number of bits. For example, if there are 2 pulses, the pulse amplitude quantizer 244 may convert the amplitude of the 2 pulses to a log scale and may thus perform vector quantization on the 2 pulses using a data table, which is obtained in advance by experiments.

The multiplexer 250 may multiplex the quantized pulse location information and the quantized pulse amplitude information provided by the quantizer 240 and the track structure determined by the track structure determiner 210 into a bitstream and may output the bitstream.

The demultiplexer 270 may demultiplex a bitstream into track structure information, quantized pulse location information and quantized pulse amplitude information. Then, the demultiplexer 270 may provide the track structure information to the track structure determiner 280 and the quantized pulse location information and the quantized pulse amplitude information to the inverse quantizer 282.

The inverse quantizer 282 may include a pulse location inverse quantizer 284 and a pulse amplitude inverse quantizer 286. The pulse location inverse quantizer 284 may inversely quantize the quantized pulse location information and may thus restore original pulse location information. The pulse amplitude inversely quantizer 286 may inversely quantize the quantized pulse amplitude information and may thus restore original pulse amplitude information.

The pulse generator 288 may generate pulses based on the restored pulse location information provided by the pulse location inverse quantizer 284 and the restored pulse amplitude information provided by the pulse amplitude inverse quantizer 286. The coefficient generator 290 may generate frequency coefficients based on the pulses generated by the pulse generator 288.

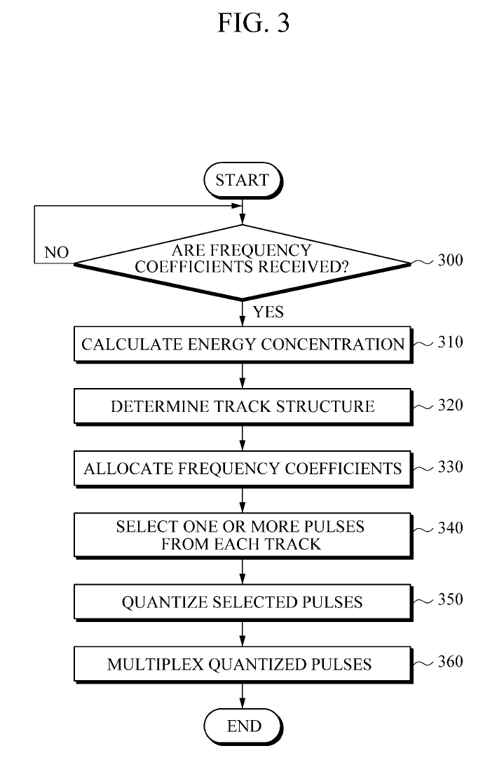

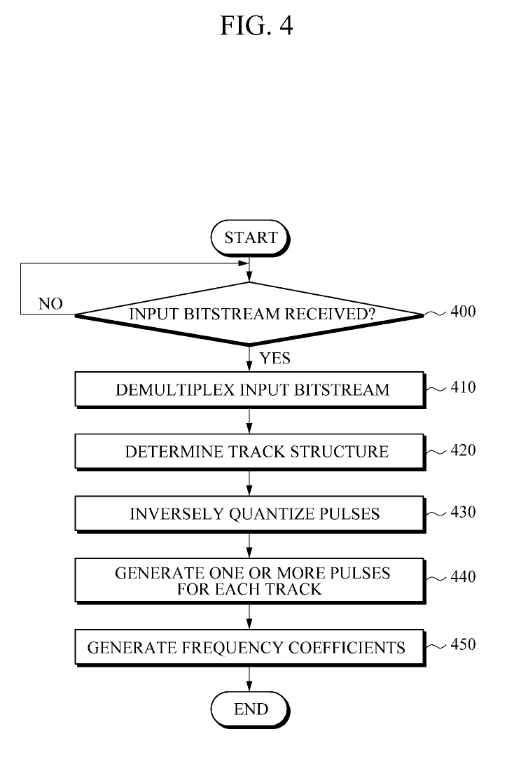

FIG. 3 is a flowchart of an example method of encoding an audio signal, and FIG. 4 is a flowchart of an example method of decoding an audio signal. Referring to FIG. 3, a plurality of frequency coefficients are received (300). Thereafter, the energy concentration level of each track structure may be calculated (310).

There are 2 track structures: a sequential track structure and an interleave track structure. For example, when there are 2 track structures (i.e., track structures 1 and 2), 64 frequency coefficients and 4 tracks (i.e., tracks 1 through 4, each having 2 pulses), the energy concentration levels of track structures 1 and 2 can be represented by Equation (3):

$${EC}_{structure 1} = {\sum }_{track = 0}^{3} \frac{{MAX 2}_{i = 0 , … , 15} {( spec ( 16 \times track + i ) )}^{2}}{\frac{1}{15} {\sum }_{i = 0}^{15} {( spec ( 16 \times track + i ) )}^{2}}$$

$${EC}_{structure 2} = {\sum }_{track = 0}^{3} \frac{{MAX 2}_{i = 0 , … , 15} {( spec ( 4 \times i + track ) )}^{2}}{\frac{1}{15} {\sum }_{i = 0}^{15} {( spec ( 4 \times i + track ) )}^{2}}$$

where

$${MAX 2}_{i = 0 , … , 15}$$

indicates 2 greatest frequency coefficients in absolute value among the frequency coefficients allocated to each of tracks 1 through 4. Referring to Equation (3), if there are 4 pulses available on each of tracks 1 through 4,

$${MAX 2}_{i = 0 , … , 15}$$

may be replaced with

$${MAX 4}_{i = 0 , … , 15}$$

where

$${MAX 4}_{i = 0 , … , 15}$$

indicates 4 greatest frequency coefficients in absolute value among the frequency coefficients allocated to each of tracks 1 through 4. In this manner, the energy concentration levels of track structures 1 and 2 may be calculated based on the number of pulses available on each of tracks 1 through 4.

The total energy levels of track structures 1 and 2 may be calculated, as indicated by Equation (4):

$${ET}_{structure 1} = {\sum }_{track = 0}^{3} {MAX 2}_{i = 0 , … , 15} {( spec ( 16 \times track + i ) )}^{2}$$

$${ET}_{structure 2} = {\sum }_{track = 0}^{3} {MAX 2}_{i = 0 , … , 15} {( spec ( 4 \times i + track ) )}^{2}$$

where

$${MAX 2}_{i = 0 , … , 15}$$

indicates 2 greatest frequency coefficients in absolute value among the frequency coefficients allocated to each of tracks 1 through 4. Referring to Equation (2), if there are 4 pulses available on each of tracks 1 through 4,

$${MAX 2}_{i = 0 , … , 15}$$

may be replaced with

$${MAX 4}_{i = 0 , … , 15}$$

where

$${MAX 4}_{i = 0 , … , 15}$$

indicates 4 greatest frequency coefficients in absolute value among the frequency coefficients allocated to each of tracks 1 through 4. In this manner, the total energy levels of track structures 1 and 2 may be calculated based on the number of pulses available on each of tracks 1 through 4.

Thereafter, one of track structures 1 and 2 may be selected by comparing track structures 1 and 2 in terms of energy concentration or total energy. For example, if EC_{structure1}>γ×EC_{structure2} (where γ is a value within the range of 0.8 to 1.2), the track structure determiner 210 may choose track structure 1 over track structure 2. On the other hand, if γ×EC_{structure2}>EC_{structure1}, the track structure determiner 210 may choose track structure 2 over track structure 1. Alternatively, if ET_{structure1}>γ×ET_{structure2}, the structure determiner 210 may choose track structure 1 over track structure 2. On the other hand, if γ×ET_{structure2}>ET_{structure1}, the structure determiner 210 may choose track structure 2 over track structure 1.

Thereafter, the received frequency coefficients may be allocated to tracks 1 through 4 according to the selected track structure (330). For example, if the selected track structure is track structure 2, a new coefficient VEC_{track}(i) may be allocated to each of tracks 1 through 4, as indicated by the following formulae:

VEC_{track1}(i)=spec(4×i), i=0, . . . , 15

VEC_{track2}(i)=spec(4×i+1), i=0, . . . , 15

VEC_{track3}(i)=spec(4×i+2), i=0, . . . , 15

VEC_{track4}(i)=spec(4×i+3), i=0, . . . , 15.

Thereafter, a number of pulses may be selected from each of tracks 1 through 4 based on the absolute values of the received frequency coefficients in decreasing order of the absolute values of the corresponding frequency coefficients (340). For example, 2 greatest frequency coefficients in absolute value may be selected from each of tracks 1 through 4.

Thereafter, location information and amplitude information of the selected pulses are quantized (350). More specifically, the pulse location information and the pulse amplitude information may be quantized using a predefined number of bits. The predefined number of bits may be determined by the number of pulse locations discovered from each of tracks 1 through 4. Similarly, the pulse amplitude information may be quantized using a predefined number of bits.

Thereafter, the quantized pulse location information and the quantized pulse amplitude information and the selected track structure may be multiplexed into a bitstream, and the bitstream may be output (360).

Referring to FIG. 4, when bitstream-type data is received (400), the received data may be demultiplexed into track structure information, quantized pulse location information and quantized pulse amplitude information (410).

Thereafter, a track structure may be determined based on the track structure information (420). Thereafter, original pulse location information and original pulse amplitude information may be restored by inversely quantizing the quantized pulse location information and the quantized pulse amplitude information, respectively (430).

Thereafter, pulses may be generated based on the determined track structure, the restored pulse location information and the restored pulse amplitude information (440). Thereafter, frequency coefficients may be generated based on the generated pulses (450).

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may is be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An encoding apparatus comprising:
a track structure determiner determining a track structure using frequency coefficients;
a frequency coefficient allocator allocating the frequency coefficients to each track according to the determined track structure; and
a quantizer quantizing one or more pulses in each track based on the frequency coefficients allocated to a corresponding track.

2. The encoding apparatus of claim 1, further comprising a calculator calculating the energy concentration levels of a plurality of track structures based on the number of pulses in each track.

3. The encoding apparatus of claim 2, wherein the track structure determiner selects one of the plurality of track structures based on the calculated energy concentration levels provided.

4. The encoding apparatus of claim 1, further comprising a calculator calculating the total energy levels of a plurality of track structures based on the number of pulses in each track.

5. The encoding apparatus of 4, wherein the track structure determiner selects one of the plurality of track structures based on the calculated total energy levels.

6. The encoding apparatus of claim 1, further comprising a pulse selector selecting one or more pulses from each track in decreasing order of the absolute values of the frequency coefficients.

7. The encoding apparatus of claim 1, wherein the quantizer comprises:
a pulse amplitude quantizer quantizing amplitude information of the selected pulses; and
a pulse location quantizer quantizing location information of the selected pulses.

8. A decoding apparatus comprising:
an inverse quantizer restoring pulse parameters by inversely quantizing quantized pulse parameters included in an input bitstream;
a track structure determiner determining a track structure based on a track parameter included in the input bitstream;
a pulse generator generating pulses based on the restored pulse parameters; and
a coefficient generator generating frequency coefficients based on the determined track structure and the generated pulses.

9. The decoding apparatus of claim 8, wherein the inverse quantizer comprises:
a pulse location inverse quantizer restoring pulse location information from the quantized pulse parameters; and
a pulse amplitude inverse quantizer restoring pulse amplitude information from the quantized pulse parameters.

10. A method of encoding an audio signal, the method comprising:
calculating the energy concentration levels of a plurality of track structures based on frequency coefficients;
selecting one of the plurality of track structures based on the calculated energy concentration levels;
allocating the frequency coefficients to each track according to the selected track structure;
selecting one or more pulses from each track; and
quantizing the selected pulses.

11. The method of claim 10, further comprising, after the quantizing of the selected pulses, multiplexing the quantized pulses and the selected track structure into a bitstream and outputting the bitstream.

12. The method of claim 10, wherein the selecting of the one or more pulses comprises selecting one or more pulses from each track in decreasing order of the absolute values of the frequency coefficients.

13. The method of claim 10, wherein the calculating of the energy concentration levels of the plurality of track structures comprises calculating the energy concentration levels of the plurality of track structures based on the number of selected pulses.

14. The method of claim 10, wherein the calculating of the energy concentration levels of the plurality of track structures comprises calculating the total energy levels of the plurality of track structures based on the number of selected pulses.

15. The method of claim 10, wherein the quantizing of the selected pulses comprises quantizing amplitude information and location information of the selected pulses.

16. A method of decoding an audio signal, the method comprising:
determining a track structure based on a track parameter included in an input bitstream;
restoring pulse parameters from the input bitstream by inversely quantizing the input bitstream;
generating pulses based on the restored pulse parameters; and
generating frequency coefficients based on the determined track structure and the generated pulses.
